(19) United States
(12) Patent Application Publication
(10) Pub. No.: US 2014/0102418 A1
(43) Pub. Date: Apr. 17, 2014

(54) OPPOSED PISTON ENGINE WITH NON-COLLINEAR AXES OF TRANSLATION

(71) Applicants: Yalamuru Ramachandra Babu, Chennai (IN); Simon David Jackson, Redwood City, CA (US); Michael Anthony Willcox, San Carlos, CA (US); James M. Cleeves, Redwood City, CA (US); Chithambaram Subramoniam, Chennai (IN); J. Vimaladas Viji Babu, Chennai (IN); Harne Vinay Chandrakant, Chennai (IN)

(72) Inventors: Yalamuru Ramachandra Babu, Chennai (IN); Simon David Jackson, Redwood City, CA (US); Michael Anthony Willcox, San Carlos, CA (US); James M. Cleeves, Redwood City, CA (US); Chithambaram Subramoniam, Chennai (IN); J. Vimaladas Viji Babu, Chennai (IN); Harne Vinay Chandrakant, Chennai (IN)

(21) Appl. No.: 14/111,989

(22) PCT Filed: Apr. 13, 2012
(86) PCT No.: PCT/US2012/033685

§ 371 Date: Dec. 26, 2013

Related U.S. Application Data
(60) Provisional application No. 61/536,401, filed on Sep. 19, 2011.

(30) Foreign Application Priority Data
Apr. 15, 2011 (IN) 1296/CHE/2011

(51) Int. Cl. F02B 75/28; F01B 7/02

(52) U.S. Cl. CPC F02B 75/28; F01B 7/02
USPC 123/51 R

(57) ABSTRACT

An opposed piston internal combustion engine can include two opposed pistons (104, 110) moving reciprocally along respective axes of translation (202, 204) that are not collinear. First and second cylinder bores (502, 504) can be inclined to each other at an included angle (a). A combustion volume or chamber (114) can optionally be defined at least in part by crowns (102, 106) of the first and second pistons (104, 110) reciprocating in the first and second cylinder bores (502, 504), respectively. Related methods, systems, and articles of manufacture are described.

### CROSS-REFERENCE TO RELATED APPLICATION

The current application claims priority to Indian Provisional Patent Application No. 1296/CHE/2011, filed on 15 Apr. 2011 and entitled “Inclined Bore Internal Combustion Engine” and to U.S. Provisional Patent Application No. 61/536,401, filed on 19 Sep. 2011 and entitled “Opposed Piston Engine with Non-Collinear Axes of Translation.” The current application is also related to issued U.S. Pat. No. 7,559,298, to U.S. Pat. No. 7,921,817, and to U.S. Patent Application Publication No. 2010/0212622. The disclosure of each document cited in this paragraph is incorporated by reference herein in its entirety to the extent permissible under applicable patent laws.

### TECHNICAL FIELD

The subject matter described herein generally relates to internal combustion engines, and more specifically to opposed piston engines in which a combustion volume or chamber is at least partially defined by piston heads or crowns of two opposed pistons that reciprocate along axes of translation within two cylinder bores that are inclined relative to one another.

### BACKGROUND

Internal combustion (IC) engines are used in a variety of applications including providing power to vehicles and other machinery. A typical, conventional IC engine includes a engine block or engine body having one or more cylinder bores, a piston reciprocating in each of the cylinder bores, at least one port, at least one valve, at least one crankshaft (which serves as a drive shaft), and at least one connecting rod. The reciprocating motion is imparted to the piston by expanding combustion products, produced as a result of ignition of a charge of combustion mixture, which can include for example a fuel (e.g. gasoline, diesel fuel, natural gas, hydrogen, liquefied petroleum gas, etc.) and an oxidant (e.g. air, oxygen, etc.), in a combustion volume or combustion chamber of the IC engine. The reciprocating motion of the piston or pistons in IC engines can be converted into a rotary motion of at least one crankshaft through a connecting rod connecting each piston to the crankshaft. In a wheeled vehicle, the motion of the crankshaft can be transmitted to the wheels through a drive train.

A combustion volume or chamber can be formed in each cylinder by a top surface or crown of the piston reciprocating in the cylinder, the walls of the cylinder bore, and a fixed cylinder head. One example of a multi-cylinder internal combustion engine having cylinder heads is a straight or in-line engine, in which the central longitudinal axes of each of the cylinder bores, also referred to as cylinder axes, are parallel to each other and lie in one plane, as do the cylinder heads. In other examples of multi-cylinder engines, for example the “V” engine, the cylinders and the corresponding pistons reciprocating therein are aligned in two separate planes or “banks” so that they appear to form a “V” shape with cylinder heads at the top of each of the arms of the “V” when the engine is viewed in a cross-section perpendicular to the axis of the crankshaft. In still other examples, for example a flat engine, multiple pistons can move in a horizontal plane such that movement of the pistons toward their respective top dead center positions occurs outwardly toward cylinder heads arranged around the exterior of the engine.

In IC engines, the compression ratio of the IC engine, which is defined as the ratio of the maximum volume of the combustion volume or chamber to the minimum volume of the combustion volume or chamber, has a direct bearing on power generated by the IC engine. The maximum volume of the combustion volume or chamber generally occurs at a bottom dead center position of the piston while the minimum volume of the combustion volume or chamber, which is also referred to as the clearance volume of the cylinder bore, generally occurs at a top dead center position of the piston. As used herein, the terms “top dead center” and “bottom dead center” are intended as relative, not absolute terms. For example, top dead center refers to a piston position at which the crown or top surface of the piston is at a distance furthest from the crankshaft to which the piston is connected by a connecting rod or other structural feature that transfers reciprocal motion of the piston into rotational motion of the crankshaft. Similarly, bottom dead center refers to a piston position at which the crown or top surface of the piston is at a distance closest to the crankshaft. Additionally, the term displacement volume as used herein refers to the volume swept by all of the pistons inside the cylinders of an internal combustion engine in single movement between top dead center and bottom dead center.

The compression ratio in a typical IC engine is typically limited by structural features, such as shape of the combustion volume or chamber and shape of the cylinder head. Heat is transferred to and conducted through the cylinder head, thereby resulting in energy losses from the internal volume and a reduction in efficiency. One way of increasing efficiency is by reducing an area of the surface of the piston and increasing a stroke of the piston, which can be defined as the distance traveled by the piston between the top dead center position and the bottom dead center position, or alternatively, as a diameter of a circle followed by an offset throw section attached to the piston via a connecting rod. A large stroke results in high forces created on the piston and other components of the engine, so that the engine can only be run at lower revolutions per minute with a corresponding reduction in power. Partial-power operation in a conventional IC engine is also less efficient than full-power operation because the partially open throttle causes the engine to do significant pumping work to pull in a fresh charge of air and/or fuel. The heat in the exhaust gas is an energy loss that results in a reduction in efficiency in addition to losses due to friction, which can also be quite high in a conventional IC engine, especially as a percentage of light load power.

### SUMMARY

In one aspect, an opposed piston internal combustion engine includes a first piston reciprocating along a first axis of translation within a first cylinder bore in an engine block, a second piston reciprocating along a second axis of translation within a second cylinder bore in the engine block, a first crankshaft configured to be rotated under influence of the reciprocating of the first piston, and a second crankshaft configured to be rotated under influence of the reciprocating of the second piston. The first piston reciprocates between a first top dead center position and a first bottom dead center position and includes a first piston crown, and the second piston reciprocates between a second top dead center position and a second bottom dead center position and includes a second piston crown. The second axis of translation is inclined at an included angle relative to the first axis of translation. The included angle has a vertex that is closer to the first and the second top dead center positions than to the first and the second bottom dead center positions. A combustion chamber within the engine is at least partially defined by the first piston crown and the second piston crown. The first crankshaft is disposed closer to the first bottom dead center position than to the first top dead center position, and the second crankshaft is disposed closer to the second bottom dead center position than to the second top dead center position.

In an interrelated aspect, a method includes reciprocating a first piston between a first top dead center position and a first bottom dead center position along a first axis of translation within a first cylinder bore in an engine block of an opposed piston internal combustion engine, reciprocating a second piston between a second top dead center position and a second bottom dead center position along a second axis of translation within a second cylinder bore in the engine block, rotating a first crankshaft under influence of the reciprocating of the first piston, and rotating a second crankshaft under influence of the reciprocating of the second piston. The first piston includes a first piston crown, and the second piston includes a second piston crown. The second axis of translation is inclined at an included angle relative to the first axis of translation. The included angle has a vertex that is closer to the first and the second top dead center positions than to the first and the second bottom dead center positions. A combustion chamber within the opposed piston internal combustion engine is at least partially defined by the first piston crown and the second piston crown. The first crankshaft is disposed closer to the first bottom dead center position than to the first top dead center position, and the second crankshaft is disposed closer to the second bottom dead center position than to the second top dead center position.

In some variations of the current subject matter, one or more of the following features can optionally be included in any feasible combination. The engine block can optionally include first and second engine block parts that respectively at least partially define the first and second cylinder bores and a connecting piece disposed proximate to the vertex of the included angle. The first and second engine block parts can optionally be joined to the connecting piece, which can also at least partially define the combustion chamber. An ignition element can optionally be disposed in the connecting piece to provide an ignition source to a combustion mixture formed in the combustion chamber and compressed by the reciprocating of the first piston and the second piston toward the first and second top dead center positions, respectively. The vertex of the included angle can optionally be disposed above a plane comprising the first and second crankshafts. A first sleeve valve can optionally be associated with the first piston to control opening and closing of an inlet port for allowing delivery of at least one of fuel and air to the combustion chamber. The first sleeve valve can optionally at least partially encircle the first piston in the first bore and move at least in a direction parallel to the first axis of translation such that in a first closed position the first sleeve valve is urged into contact with a first valve seat. A second sleeve valve can optionally be associated with the second piston to control opening and closing of an exhaust port for allowing removal of combustion gases from the combustion chamber. The second sleeve valve can optionally at least partially encircling the second piston in the second bore and move at least in a direction parallel to the second axis of translation such that in a second closed position the second sleeve valve is urged into contact with a second valve seat. At least one of the first piston crown and the second piston crown can optionally include a shaped area, which can optionally include a concavity directed toward the combustion chamber. The concavity of the shaped area can optionally be also at least partially directed toward the vertex of the included angle. The included angle can optionally be greater than 0° and less than 180° or optionally in a range of approximately 130° to 170° or optionally be one of other angles including but not limited to approximately 160°.

The details of one or more variations of the subject matter described herein are set forth in the accompanying drawings and the descriptions below of illustrative implementations. Other features and advantages of the subject matter described herein will be apparent from the description and drawings, and from the claim. The accompanying drawings, which are incorporated in and constitute a part of this specification, show certain aspects of the subject matter disclosed herein and, together with the description, help explain some of the principles associated with the disclosed implementations. For simplicity of explanation, various features consistent with one or more implementations of the current subject matter are described herein and illustrated in the accompanying drawings in reference to an engine having a single pair of opposed pistons. However, other engine configurations, including those with two or more pairs of opposed pistons, are also within the scope of the current subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a cross-sectional view of an engine design showing features of an opposed piston engine in which two opposed pistons have collinear axes of translation;

FIG. 2 is a diagram illustrating a cross-sectional view of an engine design showing features of an opposed piston engine in which two opposed pistons have non-collinear axes of translation;

FIG. 3 is a diagram illustrating an isometric view of an engine design showing features of an opposed piston engine in which two opposed pistons have non-collinear axes of translation;

FIG. 4 is a diagram illustrating a cross-sectional view of an engine design showing features of an opposed piston engine in which two opposed pistons have non-collinear axes of translation;

FIG. 5 is a diagram illustrating a cross-sectional view of an engine design showing features of an opposed piston engine in which two opposed pistons have non-collinear axes of translation;

FIG. 6 is a process flow diagram illustrating aspects of a method having one or more features consistent with implementations of the current subject matter; and

FIG. 7 is a process flow diagram illustrating aspects of another method having one or more features consistent with implementations of the current subject matter.

When practical in the instant specification and in the accompanying figures, similar reference numbers denote similar structures, features, or elements.

### DETAILED DESCRIPTION

Opposed piston geometries can be used in internal combustion engines to minimize or at least reduce the energy loses that are characteristic of conventional IC engines, to increase the compression ratio, and hence, the power generated. In a conventional internal combustion engine having opposed piston geometry, two pistons share a common cylinder bore, or said another way, the cylinder bores within which the two opposed pistons reciprocate are joined at an end opposite a crankshaft end of each of the respective cylinder bores. In such a conventional opposed piston IC engine, the cylinder bores within which the two opposed pistons reciprocate have collinear central longitudinal axes, which are also referred to herein as cylinder axes and axes of translation of the pistons.

A combustion volume or chamber in an opposed piston IC engine can be defined at least partially by the top surfaces or crowns of the two facing pistons. The combustion volume or chamber of such an engine can be further defined by two connected cylinder bores housing the two opposed pistons, optionally by a connecting piece or other feature at which engine block parts at least partially defining the two cylinder bores are joined, and optionally by one or more sleeve valves associated with the two opposed pistons to control opening and closing of one or more ports. The one or more ports can include, for example, inlet ports for allowing delivery of at least one of fuel and air or some other oxidizer to the combustion volume or chamber to form a combustion mixture, scavenging or exhaust ports for allowing removal of combustion gases from the combustion volume or chamber, and the like. Such engines can include at least joined two cylinder bores, and the central longitudinal axes, also referred to as cylinder axes, of the two cylinder bores generally coincide.

The pistons in the two cylinder bores are each connected through a respective connecting rod to one of two independent crankshafts located proximately to crankshaft ends of the respective cylinder bores. The power from one crankshaft can be added to the power of the other crankshaft by using a crank train assembly, which can, for example, be provided between the two crankshafts and disposed on one side of the engine. Such a crank train assembly can include a plurality of gears and can fill the gap between the two crankshafts. Alternatively, one or more belts, chains, screw drives, gear shafts, or the like can be used to couple the two independent crankshafts. During an engine cycle, the combustion volume or chamber varies in size from a minimum size when the pistons are at combustion ends of the respective cylinder bores, for example at respective top dead center positions, to a maximum size when the pistons are at the crankshaft ends of the respective cylinder bores, for example at respective bottom dead center positions.

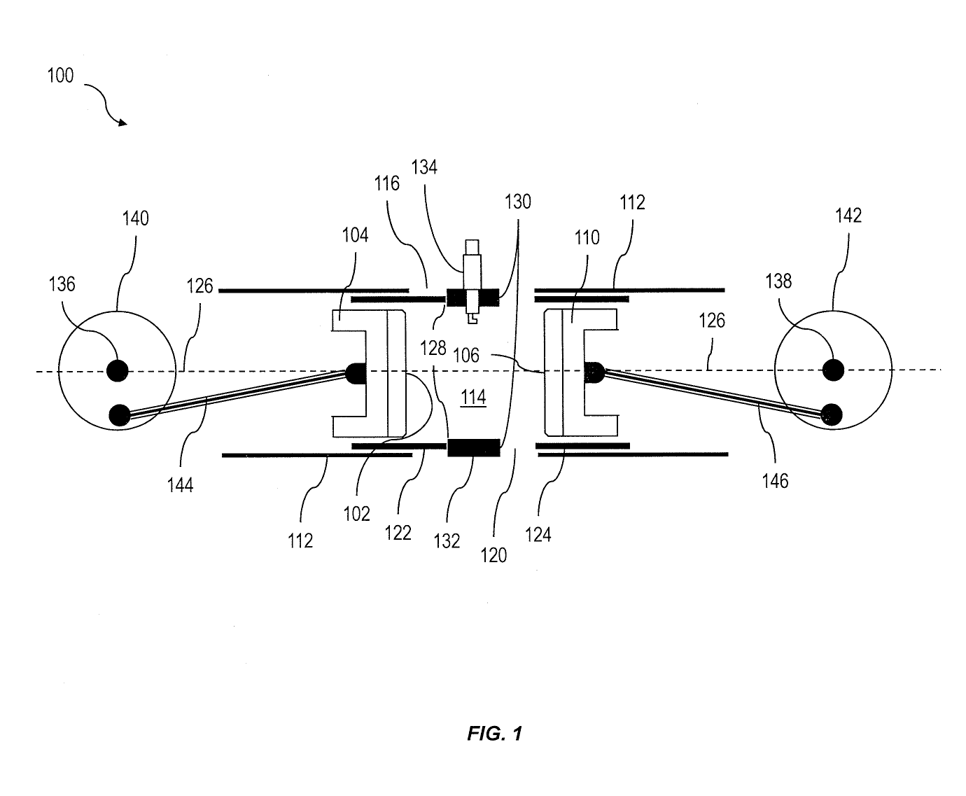

As illustrated in the diagram of FIG. 1, which shows a schematic diagram depicting features of a conventional opposed piston engine 100, a first piston crown 102 of a first piston 104, a second piston crown 106 of a second piston 110, and walls 112 of the cylinder bores generally at least partially define a combustion volume or chamber 114 into which a combustion mixture is provided by delivery of oxidizer and fuel via one or more intake ports 116 and optionally via one or more direct fuel injectors (not shown) and from which burned combustion gases are exhausted via one or more exhaust ports 120. One approach to opposed piston engines involves the use of sleeve valves 122, 124 to control flow through the one or more intake ports 116 and the one or more exhaust ports 120. The sleeve valves 122, 124 can move at least in a direction parallel to an axis of translation 126 of the pistons 104, 110, and in some implementations can be configured such that in a closed position they are each urged into contact with a respective valve seat 128, 130 that can optionally be part of a center ring or other connecting piece 132 joining two parts of an engine block that each at least partially define part of the walls 112 of the cylinder bores. Either or both of the sleeve valves 122, 124 can be associated with one of the opposed pistons 104, 110 and can at least partially encircle the piston 104, 110 with which it is associated.

In a spark-ignited engine, the center ring or other connecting piece 132 or its equivalent can also provide a pass-through for one or more ignition elements 134, which can be, for example one or more spark plugs, to provide an ignition source to combustion mixture formed in the combustion chamber and compressed by the reciprocating action of the first piston and the second piston respectively toward respective first and second top dead center positions of the first piston 104 and second piston 110. Each piston 104, 110 can be connected to a respective crankshaft 136, 138, for example via a respective offset throw bearing 140, 142 connected to the piston by a respective connecting rod 144, 146.

In addition to the examples shown and described herein, an opposed piston engine can also employ valves other than sleeve valves. For example, one or more poppet valves can be disposed in the center ring or other connecting piece 132. In other implementations utilizing one or more sleeve valves, the one or more sleeve valves can move in a continuous or semi-continuous motion that can involve either or both of rotational motion about the piston axis of translation 126 and translational motion in a direction parallel to the axis of translation 126 of the pistons 104, 110.

Despite numerous advantages presented by opposed piston engines sharing one or more of the features discussed in relation to FIG. 1, some difficulties can arise with this configuration. For example, in an engines with a small displacement volume, or alternatively, with a small minimum size of the combustion chamber or volume 114 defined between the two opposed pistons 104, 110, a linear configuration of the cylinder bores in which the two pistons 104, 110 share a common axis of translation 126 can present challenges in placing the ignition element 134. Space for placement of one or more ignition elements 134 in the connecting piece 132 may not be available between the piston crowns 102, 106 at the top dead center position of the pistons 104, 110. A small engine having a small cylinder diameter can facilitate obtaining reasonable flame travel distances using only one ignition element 134. However, in a conventional engine geometry with both pistons 104, 110 traveling along a common translation axis 126, extending the distance between the pistons 104, 110 to fit a conventional spark plug or similarly sized ignition element 134 can have a negative impact on both the compression ratio and the surface area of the combustion volume or chamber 114.

A fully collinear configuration of the opposed pistons 104, 110 can also result in the engine having a substantial width to accommodate the two offset throw bearings 140, 142 and the respective crankshafts 136, 138 positioned outboard of the bottom dead center position of each of the opposed pistons 104, 110. Such engines are generally longer than non-opposed piston engines of comparable displacement volume because of the end-to-end orientation of the cylinder bores, and hence, can be bulky. The presence of two crankshafts 136, 138 and other moving and supporting structural features associated with the two crankshafts 136, 138 near the outboard ends of the respective cylinder bores can increase the weight of the engine at least because structural elements having significant size and weight can also be necessary to support the two crankshafts 136, 138 and to transfer the motion of the opposed pistons 104, 110 to a vehicle drive shaft via a drive train or other mechanism linking the two separate crankshaft assemblies. The term “crankshaft assemblies” is used herein to refer to the additional moving and supporting structural features, including but not limited to the offset throw bearings 140, 142 respectively associated with each of the two crankshafts 136, 138. Increases in either or both of the size and the weight of the engine 100 can increase an overall size and/or weight and thereby reduce the fuel economy of the vehicle.

In addition, the packaging of an opposed piston engine 100 having collinear cylinder bores and a common axis of translation 126 along which the pistons 104, 110 reciprocate is usually done in a way that a central axis of the engine 100 is almost parallel to a central axis of the vehicle, for example, a two-wheeled vehicle. As a result of such packaging, engine oil in certain parts of the engine 100 may not flow under the effect of gravity. Rather, in some examples, a separate pump for lubricating and cooling the different parts of the engine 100 can be required. Stagnation of oil can also occur at the bottom of the pistons 104, 110 due to the aforementioned packaging and orientation of the engine 100 in the vehicle as drainage of lubricating oil from the walls 112 of the cylinder bores and other internal components of the engine 100, for example after engine shut-off, can be less than ideal. Some pooling or seepage of the lubricating oil past one or more piston rings forming a seal around each of the pistons 104, 110 into the combustion volume or chamber 114 can occur. As a result of such seepage, the lubricating oil may undergo combustion during operation of the engine, leading to smoking or oil burnoff when the engine 100 is started, which can result in reductions in performance (particularly at start-up), increased consumption of oil (which can lead to more frequent maintenance requirements), increased emission of pollutants (which may fail to satisfy the various norms and policies related to pollution controls), and the like.

To address these and potentially other issues with currently available solutions or, alternatively, to provide one or more other benefits or advantages, one or more implementations of the current subject matter provide can relate to an opposed piston engine configuration in which two opposed pistons 104, 110 that form part of a combustion volume or chamber 114 do not share a common, for example a collinear, axis of translation. The two opposed pistons 104, 110 still move opposite to one another and their respective top surfaces or crowns 102, 106 each partially define part of a single, common combustion volume or chamber 114 whose volume is compressed to or near a minimum volume when the two opposed pistons are at their respective top dead center positions. However, unlike a conventional opposed piston engine (e.g. the engine 100 shown in FIG. 1) in which axes along which the two opposed pistons are translated during their reciprocating motion are collinear, in implementations of the current subject matter, the two axes are inclined relative to each other at an angle that is greater than 0° and smaller than 180°. Such an angle can be measured in a plane defined by the axes of translation of the two opposed pistons 104, 110 as discussed kin greater detail below.

Generally, in implementations of the current subject matter, an inclined bore opposed piston engine can include a first cylinder bore and a second cylinder bore inclined to each other at an included angle α (e.g. an angle formed at the common vertex of the non-collinear axes of the two cylinder bores that respectively define axes of translation of the two pistons 104, 110 reciprocating within the cylinder bores) and optionally separated by a center or connecting piece 132. The center or connecting piece 132 can be disposed proximate to the vertex of the included angle α and can optionally be joined to first and second engine block parts that respectively at least partially define walls 112 of the first and second cylinder bores. In some implementations discussed in greater detail below, a top surface or crown 102, 106 of at least one of the two opposed pistons 104, 110 can include a shaped area that can optionally define a concave profile such that the concavity is directed toward the combustion volume or chamber formed between the two piston crowns.

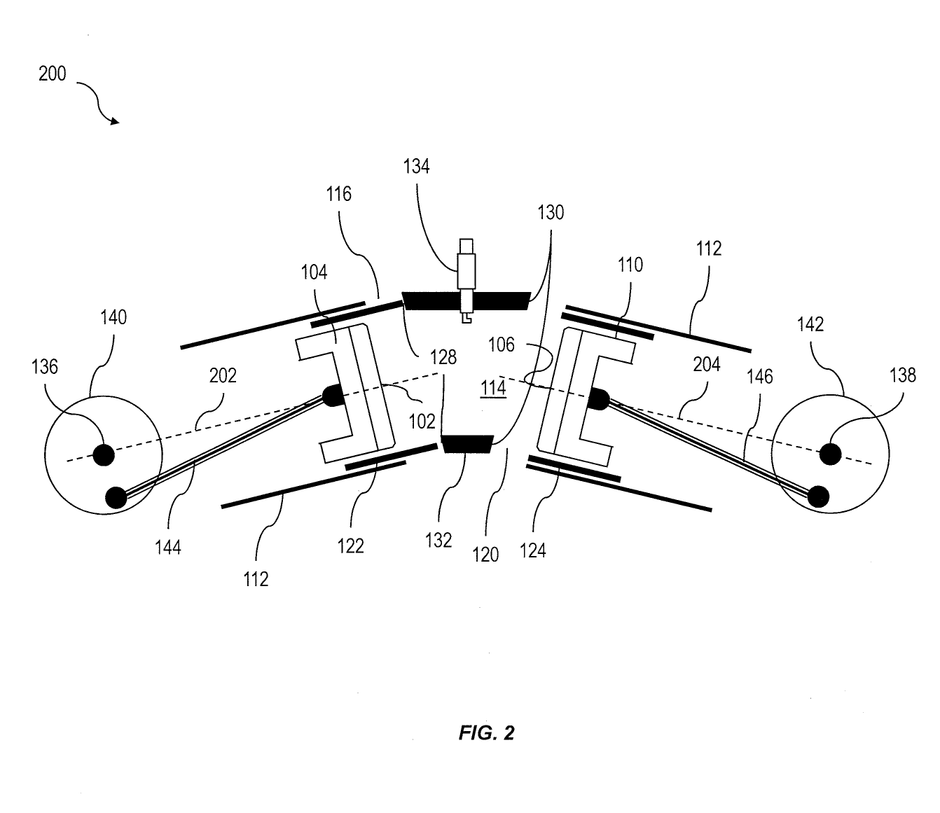

FIG. 2 shows a schematic diagram of an opposed piston engine 200 having features consistent with at least one implementation of the current subject matter. Unlike in the opposed piston engine 100 shown in FIG. 1 and discussed above, the engine 200 does not include a common axis of translation 126 along which both of the opposed pistons 104, 110 reciprocate. Instead, the first piston 104 has a first axis of translation 202, and the second piston 110 has a second axis of translation 204. The two axes of translation 202, 204 can be arranged at an included angle α to one another. In the engine 200 of FIG. 2, the center or connecting piece 132 can be larger on one side of the engine block than it is on an opposite side of the engine block. If, as shown in FIG. 2, the two axes of translation 202, 204 form an inverted “V” shape, the center or connecting piece 132 can have a larger area between the joined cylinder bores at a side of the of the center or connecting piece 132 oriented away from a plane in which the two crankshafts 136, 138 are disposed. In the view of FIG. 2, the center or connecting piece 132 has a larger length between the parts of the engine block at least partially defining the two cylinder bores at the top of the center or connecting piece 132 than at the bottom. The larger area of the center or connecting piece 132 can provide additional clearance to position one or more ignition elements 134 such that the ignition tip of a spark plug or other ignition element 134 can be a sufficient distance from both piston crowns 102, 106 at the respective top dead center positions of the two pistons 104, 110. Each of the two sleeve valves 122, 124 can move at least in a direction parallel to an axis of translation 202, 204 of the respective piston 104, 110 such that in a closed position each sleeve valve 122, 124 is urged into contact with a respective valve seat 128, 130 that can be part of the center ring or other connecting piece 132 joining two parts of the engine block.

It should be noted that while one ignition element 134 is shown in FIG. 2, engines with more than one ignition element, such as for example multiple spark plugs, are also within the scope of the current subject matter. In an alternative implementation, if the engine 200 is a diesel or other engine in which fuel or a fuel-air mixture is directly injected into the combustion volume or chamber 114, the ignition element 134 can instead be a diesel injector or other direct fuel or air/fuel injection mechanism positioned at a similar location as is shown in FIG. 2 for the ignition element 134.

Consistent with the discussion above of FIG. 2, a lateral midpoint of the combustion volume or chamber 114 formed at the junction of two cylinder bores containing opposed pistons 104, 110, for example at the halfway point between the crankshafts 136, 138 or at or near the vertex of the included angle α, can be shifted out of a plane that contains the two crankshafts 136, 138. The term lateral midpoint refers to a location that is equidistant from each of the two crankshafts 136, 138 of an opposed piston engine and located within the combustion volume or chamber 114. As an illustrative example, if a plane containing the two crankshafts 136, 138 is considered to be horizontal, the lateral midpoint of the combustion volume or chamber 114 can be positioned either above or below this plane containing the two crankshafts 136, 138. Use of the relative term “above” in this context should be readily understood to indicate the plane containing the two crankshafts 136, 138 is disposed vertically beneath the vertex of the included angle in the part of this plane that lies between the two crankshafts 136, 138. For example, even if the plane containing the two crankshafts 136, 138 is not horizontal (e.g. the plane is inclined at some angle relative to horizontal), the vertex of the included angle can be considered “above” the plane if a line extending vertically downward from the vertex would intersect the plane.

Such a bent or inclined engine configuration can bring one portion of the piston crowns 102, 106 of two opposed pistons 104, 110 closer together while leaving another portion of each of the piston crowns 102, 106 further apart than would occur in a conventional linear opposed piston engine configuration, such as is illustrated in the engine shown in FIG. 1. The larger opening provided by the piston spacing can allow for a conventional spark plug 134 to be used, even in a small displacement engine where the total space or clearance in which to position a spark plug 134 might be quite limited.

It should be noted that, while an engine block configuration having separate parts that at least partially define cylinder walls 112 associated with each of the two opposed pistons 104, 110 joined by a center ring or other connecting piece 132 can provide advantages such as ease of construction and assembly, other engine block configurations are also within the scope of the current subject matter. For example, the center ring or other connecting piece 132 can be formed as part of the aforementioned two parts of an engine block rather than being an independent third part. An engine block can have any number of parts that are joined by any of a variety of attaching means to construct a completed engine block.

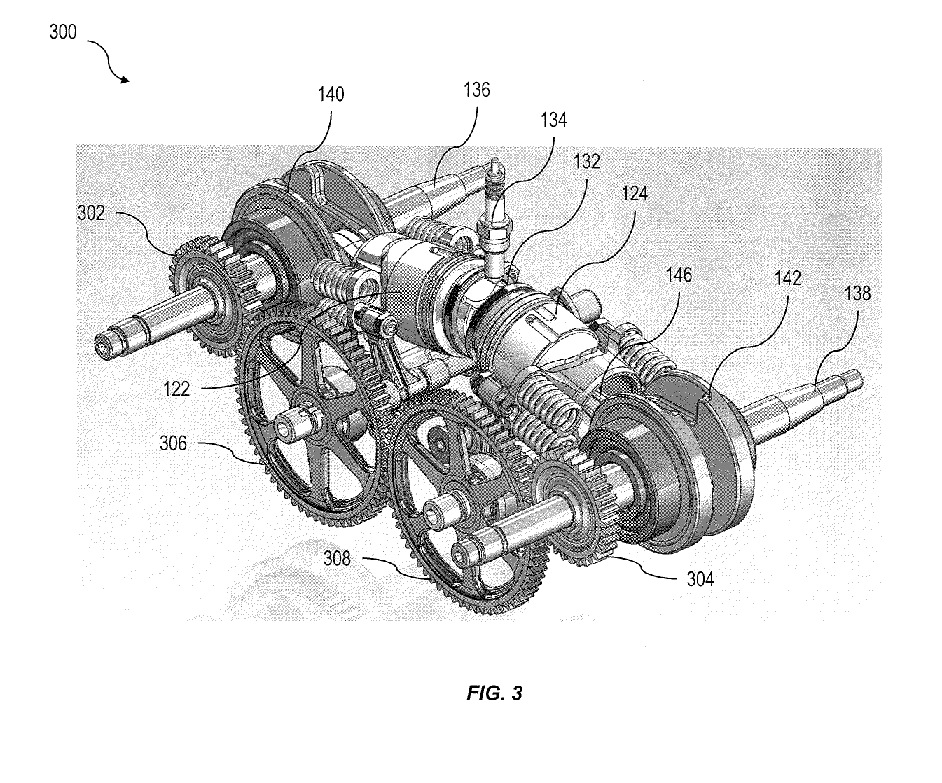

FIG. 3 shows an isometric view of an engine 300 having one or more features consistent with the current subject matter. As shown in FIG. 3, a connecting piece 132 is elevated out of the plane in which the two crankshafts 136, 138 are disposed such that the axes of translation 202, 204 (not labeled in FIG. 3) of the two opposed pistons 104, 110 are not collinear. An ignition element 134 positioned in the larger side of the center or connecting piece 132 (e.g. in the side of the center or connecting piece 132 oriented away from a plane containing the two crankshafts 136, 138) has ample clearance between the piston crowns 102, 106. In one implementation illustrated in the engine 300, the first crankshaft 136 can include a first crankshaft gear 302 and the second crankshaft 138 can include a second crankshaft gear 304 that communicate motion of the two crankshafts 136, 138 via one or more camshaft gears 306, 308 and/or other intermediate gears. In such a configuration, one of the first crankshaft 136 and the second crankshaft 138 can be the vehicle drive shaft or otherwise part of the vehicle drive train. The bent configuration of the engine 300 relative to the engine 100 of FIG. 1 reduces the overall length between the first crankshaft 136 and the second crankshaft 138, thereby reducing engine bulk, mass, and moment of inertia. Additionally, various structures in the engine design can be reduced in size by bringing the first crankshaft 136 and the second crankshaft 138 closer together such that fewer or smaller components are required in the drive train coupling the two drive shafts.

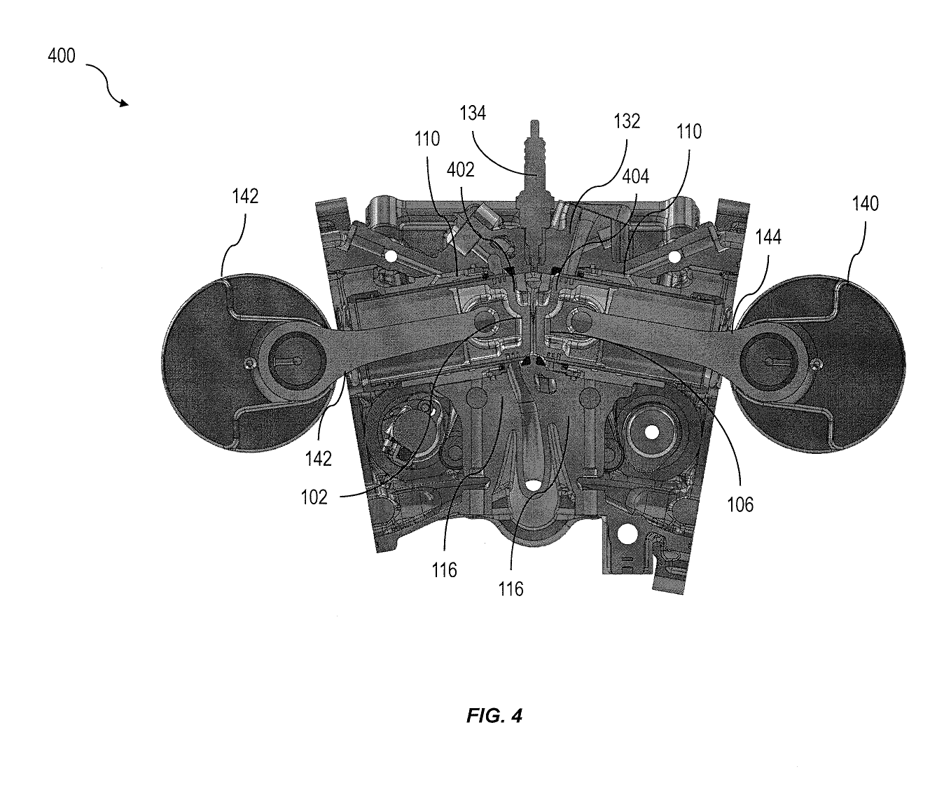

FIG. 4 shows a cross-sectional diagram of an engine 400 illustrating features consistent with implementations of the current subject matter. In this example, one or both of the piston crowns 102, 106 can include respective shaped areas 402, 404 designed to cause a “squish” effect to occur during compression of a combustion mixture in the combustion volume or chamber 114. These shaped areas 402, 402, which can be formed on either or both of the piston crowns 102, 106, can in some implementations define a concave profile such that the concavity is directed toward the combustion volume or chamber 114 formed between the two piston crowns 102, 106. The concavity of the shaped areas 402, 404 can also optionally be directed toward the vertex of the included angle α. For example, the concavity of the shaped area or areas 402, 404 on either or both of the piston crowns 102, 106 can be directed at least partially toward the part of the center or connecting piece 132 that has a larger area between the joined cylinder bores such that the combustion volume or chamber 114 is preferentially formed closer to the this part of the center or connecting piece 132 having the larger area.

In one implementation, the curved or otherwise shaped profiles one or more concave piston crown profiles can substantially define a hemisphere-shaped combustion volume or chamber 114 in conjunction with at least an inner wall surface of the center connecting piece 132 when the two opposed pistons 104, 110 are at their respective top dead center positions. The minimal region of the combustion volume or chamber 114 that occurs at the point where the piston crowns 102, 106 are closest (e.g. where either or both of the two opposed pistons 104, 110 are at their respective top dead center positions or at a point of maximum compression of gases in the combustion chamber or volume 114) can be generate turbulence and push all or most of the combustion mixture closer to the ignition element 134 (e.g. in a engine that includes an ignition element or elements 134), thereby shortening the flame travel distance and speeding combustion. In other implementations, a concave or other-shaped profile on one or both of the piston crowns 102, 106, can at least partially form a combustion volume or chamber 114 shaped similarly to a quarter sphere. It will be understood that other shapes, including but not limited to oval shaped, conical shaped, pent-roof shapes, or the like, are also within the scope of the current subject matter.

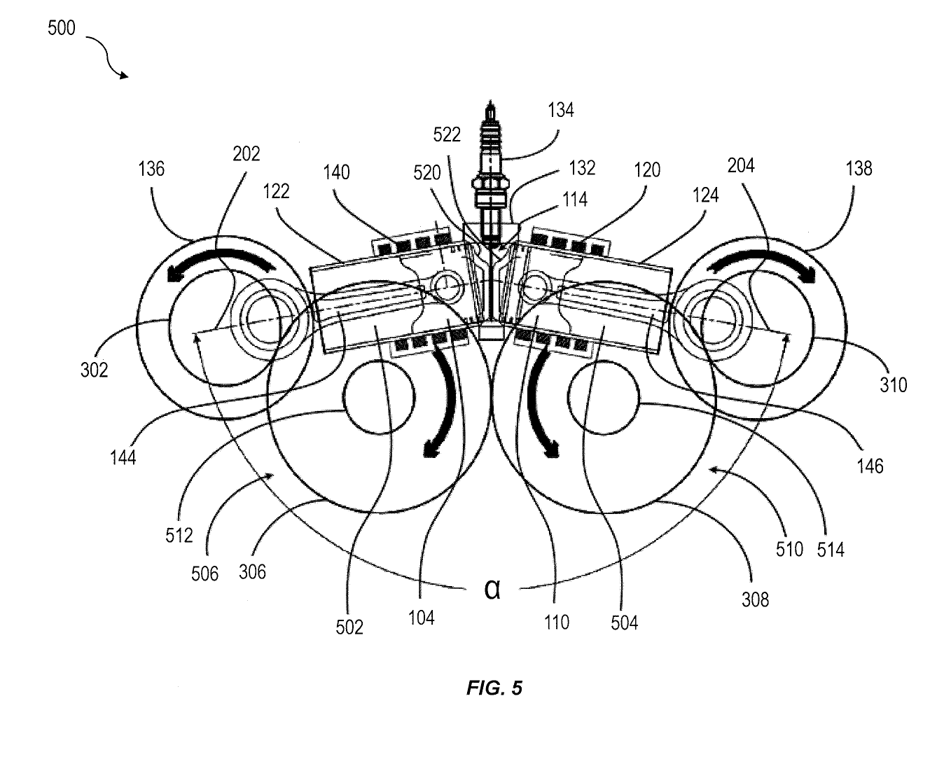

FIG. 5 illustrates a cross-sectional view of an inclined bore internal combustion (IC) engine 500 having at least some features similar to those described above. The engine 500 is a twin-cylinder internal combustion engine that includes a cylinder block that at least partially defines a first cylinder bore 502 and a second cylinder bore 504. In this implementation, the cylinder block further includes a center, connecting piece 132, which separates the first cylinder bore 502 and the second cylinder bore 504. The cylinder block can optionally be formed as a single component having the first cylinder bore 502, the second cylinder bore 504, and the connecting piece 132. Alternatively, the cylinder block can be formed as a plurality of cylinder block portions, with various of the cylinder block portions having the cylinder bores 502, 504 formed therein and the connecting piece 132 positioned between the cylinder block portions.

In some implementations, the first cylinder bore 502 and the second cylinder bore 504 are inclined to each other. In one example, a first cylinder bore axis 202 and a second cylinder bore axis 204 are inclined to each other such that an included angle α between the first cylinder bore axis 202 and the second cylinder bore axis 204 is less than 180°. It will be understood that the first and second cylinder bores axes 202, 204 discussed in reference to FIG. 5 are equivalent to the axes of translation 202, 204 of the first piston 104 and the second piston, 110 reciprocating within the respective first and second cylinder bores 502, 504. In various implementations, the included angle α can be approximately 170°, approximately 160°, approximately 150°, approximately 140° or the like. In other implementations, the included angle α can be in a range of approximately 130° to 170°, in a range of approximately 120° to 160°, or the like. Other included angles α are also within the scope of the current subject matter and apply to any of the engine configurations described herein, including but not limited to those described in reference to FIG. 2, FIG. 3, and FIG. 4. The included angle α can be understood as an angle formed between the first cylinder bore 202 of the first cylinder bore 502 and the second cylinder bore 204 of the second cylinder bore 504, for example measured from the second cylinder bore 204 as depicted in FIG. 5 in a counter-clockwise direction. As noted above, the first cylinder bore 202 and the second cylinder bore 204 in this example can also be understood as the axes of translation 202, 204 of the first and second pistons 104, 110, respectively.

A first crankcase (not shown in FIG. 5) can be disposed at the crankshaft end of the first cylinder bore 502. The first crankcase can house a first crankshaft 136, which can be connected to the first piston 104, reciprocating in the first cylinder bore 502, through a first connecting rod 144. Similarly, a second crankcase (not shown in FIG. 5) can be disposed at a second crankshaft end of the second cylinder bore 504. The second crankcase can house a second crankshaft 138, and can be connected to the second piston 110 through a second connecting rod 146. The second piston 110 can reciprocate in the second cylinder bore 504.

A first sleeve of a first sleeve valve 122 and a second sleeve of a second sleeve valve 124 can be disposed in the first cylinder bore 502 and in the second cylinder bore 504, respectively. The first and second sleeve valves 122, 124 can each serve as a liner for the first cylinder bore 502 and the second cylinder bore 504, respectively. For example, the first sleeve valve 122 and the second sleeve valve 124 can be disposed in the respective cylinder bores 502, 504 such that the sleeve valves 122, 124 are capable of sliding in the respective cylinder bores 502, 504 along a direction of the cylinder bore or axes of translation 202, 204 of the respective pistons 104, 110. The engine 500 can optionally include a first actuator assembly 506 (partially shown in FIG. 5) and a second actuator assembly 510 (partially shown in FIG. 5) to actuate the first sleeve valve 122 and the second sleeve valve 124, respectively.

In one implementation, the first actuator assembly 506 can include a first rocker arm assembly and a first cam (not shown in FIG. 5). The first cam can be mounted on a first camshaft 512. A first camshaft gear 306 can be part of a gear train coupled to the first camshaft 512 to provide a drive to the first camshaft 512, and hence, to the first cam. In one example, the first camshaft gear 306 is further coupled to the first crankshaft 136 to provide the drive to the first camshaft 512. The first crankshaft 136 can optionally include the first crankshaft gear 302, which directly meshes with the first camshaft gear 306 to drive the first camshaft 512. Alternatively, the first camshaft gear 306 on the first crankshaft 136 can mesh with one or more other intermediate gears in the gear train to be indirectly driven at least in part by the first crankshaft 136. As such, the first camshaft 136 drives the first cam, which actuates the first rocker arm. In return, the first rocker arm actuates the first sleeve valve 122 in the first cylinder bore 502.

The first sleeve valve 122 can include one or more inlet apertures (not shown in FIG. 5) for allowing delivery of a charge of air, fuel, or an air/fuel mixture to be inducted into the first cylinder bore 502. The cylinder block can include one or more inlet ports 116 that are connected to a fueling system or alternatively to an air supply system (not shown in FIG. 5) of the engine 500. In some examples, the fueling system can include a carburetor or a fuel injection system or other systems or apparatus for supplying fuel to the combustion volume or chamber 114. An air supply system or a fuel supply system can include one or more air manifolds, etc. for conveying air to the combustion volume or chamber 114. The actuation of the first sleeve valve 122 by the first actuator assembly 506 can regulate an opening and closing of the inlet ports 116 through movement of the first sleeve valve 122. In an implementation, the opening and closing of the inlet ports can be achieved by the first actuator assembly 130 actuating the first sleeve valve 122 to align the inlet apertures in the first sleeve valve 122 with the inlet ports 116 to uncover the one or more inlet ports 116 and allow entry of air or a premixed combustion charge into the first cylinder bore 502. The first sleeve valve 122 can optionally be spring loaded on one end to keep the inlet ports 116 closed until the first sleeve valve 122 is actuated to open the inlet ports 116. In optional variations, the closing of the one or more inlet ports can occur through a sealing edge of the first sleeve valve 122 being urged into contact with a sealing surface of a valve seat, which can be formed as part of the center or connecting piece 132 or as a separate piece disposed near the center or connecting piece 132 or connected thereto.

In a similar manner as described above, the second actuator assembly 510 achieves the actuation of the second sleeve valve 124. The second actuator assembly 510 can optionally include a second rocker arm assembly and a second cam (not shown in FIG. 5). The second cam can be mounted on a second camshaft 514, which can optionally be driven at least partially by the first crankshaft 136 through the gear train. In another implementation, the second camshaft 514 can be at least partially driven by the turning of the second camshaft 138 under the influence of the movement of the second piston 110. For example, a second crankshaft gear 308 can mesh one or more intermediate gears in the gear train 144 to drive the second camshaft 514. In another implementation, the second crankshaft gear 304 can directly mesh with a second camshaft gear 308 to drive the second camshaft 514.

The second sleeve valve 124 can optionally include one or more exhaust apertures (not shown in FIG. 5), that align with one or more exhaust ports 120 in the cylinder block to uncover the exhaust ports 120 and to allow combustion products in the second cylinder bore 504 to escape. The alignment of the exhaust apertures in the second sleeve valve 124 and the exhaust ports 120 can be achieved by the second actuator assembly 510 in a similar manner to that described with reference to the first sleeve valve 122.

The first actuator assembly 506 and the second actuator assembly 510 can, in conjunction with the gear train, provide smooth and substantially noise-less operation of the engine 500. Such features can also assist in achieving light weight and a compact layout of the engine 500. In other implementations, the first actuator assembly 506 and the second actuator assembly 510 can include electromagnetic actuators, rack and pinion-type actuators, or other types of actuators.

In one implementation, the first crankshaft 136 can mesh with the second crankshaft 138, for example through the gear train as shown in FIG. 5. An engine consistent with implementations of the current subject matter can be mounted on a body of a vehicle, for example with the gear train disposed such that the axes of the various gears in the gear train are vertically below the first cylinder bore axis 202 and the second cylinder bore axis 204 if the engine 500. Vertical positioning in this example is in reference to a road or other surface upon which a vehicle is supported assuming that the engine is oriented in the vehicle with the plane containing the first and second crankshafts 136, 138 being oriented substantially parallel to the plane of a wheelbase of the vehicle and the two axes of translation 202, 204 of the two opposed pistons 104, 110 directed upward above the plane containing the first and second crankshafts 136, 138. With such a positioning of the gear train, the center of gravity of the engine can be kept relatively low and close to the surface on which the vehicle is supported. As a result of the low center of gravity of the engine, the stability of the vehicle during operation can be improved.

A first crank offset can optionally be provided between the first piston 104 and the first crankshaft 136, and a second crank offset can be provided between the second piston 110 and the second crankshaft 138. The first crank offset and the second crank offset can optionally be in a range of approximately 2 millimeter (mm) to 8 mm. In one example, the first crank offset and the second crank offset can be approximately 5 mm. The crank offset between each of the pistons 104, 110 and its respective crankshaft 136, 138 can reduce the load on joints between the pistons 104, 110 and the respective crankshafts 136, 138, and can reduce a rubbing of the pistons 104, 100 with the cylinder wall 112 during operation of an engine consistent with implementations of the current subject matter, thereby lowering the piston induced friction. Additionally, such a crank offset can reduce oil churning in the engine. The first crank offset and the second crank offset can optionally be provided in such a way that the first crankshaft 136 rotates in a direction opposite to the direction of rotation of the second crankshaft 138. Such opposite directions of rotation of the first crankshaft 136 and the second crankshaft 138 can reduce vibrations of the engine and improve ride quality of the vehicle on which the engine is mounted.

As noted above, one or more ignition elements 134 can be disposed in or otherwise provided access to the combustion volume or chamber 114 of an engine consistent with implementations of the current subject matter to achieve combustion of the compressed charge in the combustion volume or chamber 114. In one example of a spark ignition engine, the ignition element 134 can be a spark plug. The ignition element 134 can optionally be disposed in a through opening in a lateral wall of the connecting piece 132. In some implementations, the one or more ignition elements 134 can be disposed in the combustion volume or chamber 114 in such a way that substantially complete combustion of the charge can be achieved in the combustion volume or chamber 114. It will be understood that any number of ignition elements 134 can be provided in the combustion volume or chamber 114 consistent with the currently disclosed subject matter, so as to achieve a substantially complete combustion of the charge in the combustion volume or chamber 114.

Alternatively, in an example of a compression ignition engine (e.g. a diesel engine, a homogeneous charge-compression engine, or the like), the ignition element 134 shown in the various figures accompanying this description can be a diesel injector, for example if the internal combustion engine is a diesel engine rather than a spark-ignited engine, or the ignition element 134 can be a pre-mixed fuel injector, for example, if an engine consistent with implementations of the current subject matter is a homogeneous charge-compression engine. A glow plug can also optionally be included, for example for assisting in starting of a compression ignition engine during cold weather. One or more glow plugs can be located some distance from the injector so that they are sprayed with fuel on injection. A diesel injector can advantageously be located near the center of the combustion volume or chamber 114. However, the diesel injector or the premixed fuel injector can also optionally be oriented elsewhere in the combustion volume or chamber 114 depending on the dimensions of the combustion volume or chamber 114.

An engine consistent with implementations of the current subject matter can further include an oil pump for supplying oil to various parts of the engine 500, for example, to the cylinder block, to the first and second crankshafts 136, 138, etc. The oil pump can optionally provide the oil to the various parts of the engine for the purpose of lubrication and cooling of the parts. In some implementations, the oil pump can be mounted on a bottom side of the cylinder block, (for example toward the bottom of the engine as depicted in FIG. 5) and can optionally be driven from either one of the first crankshaft 136, the second crankshaft 138, or even by the first or second camshaft gears 306, 308 or by one or more other elements of an engine consistent with implementations of the current subject matter. An oil sump (not shown in FIG. 5) can optionally be formed at the bottom side of the cylinder block for the accumulation of the oil. By locating the oil pump and the oil sump at a bottom side of the cylinder block of the engine an adequate supply of oil can be provided to the various parts of the engine even at low oil levels in the oil sump.

Consistent with one or more implementations of the current subject matter, for example optionally including any of the engines 200, 300, 400, or 500 discussed herein, a center or connecting piece 132 can be formed as a hollow cylinder having opposed end surfaces at either of the two ends of the hollow cylinder. These end surfaces of the center or connecting piece 132, can adjoin respective connecting end surfaces of respective engine block pieces, for example engine block pieces forming the first cylinder bore 502 and the second cylinder bore 504. Accordingly, these end surfaces of the center or connecting piece 132 can optionally be inclined to each other at an angle of 180−α. In an example with reference to the engine 500 or FIG. 5, the connecting end surfaces of the respective engine block pieces forming the first cylinder bore 502 and the second cylinder bore 504 can be orthogonal to the respective first cylinder bore axis 202 and second cylinder bore axis 204 such that when each connecting end surface joins to the respective end surface of the connecting piece 132, the first cylinder bore axis 202 and second cylinder bore axis 204 define the included angle α.

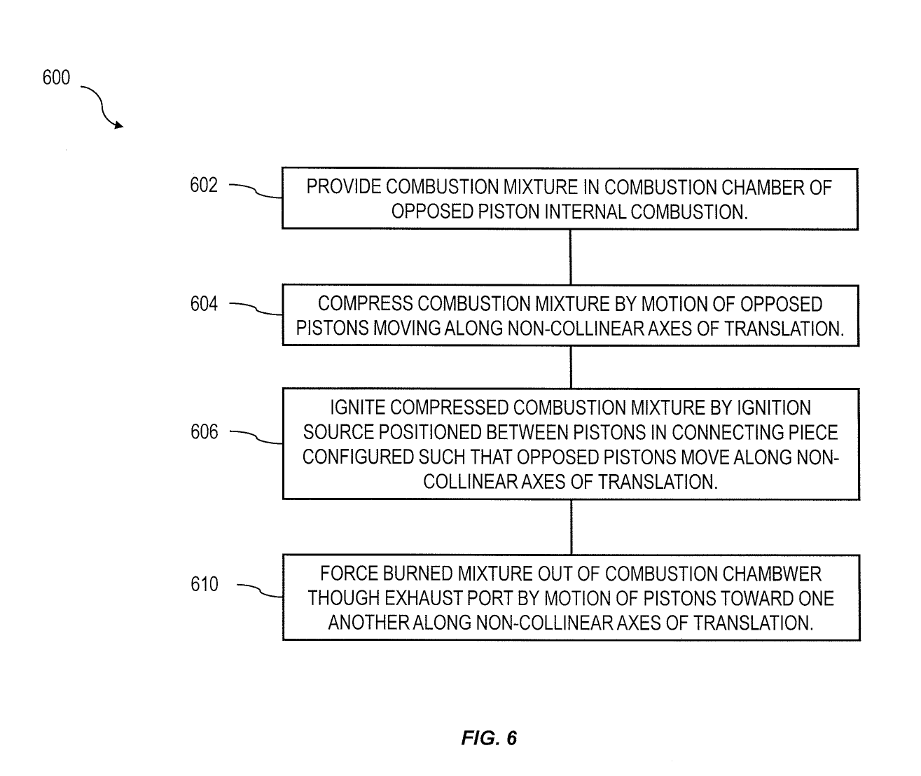

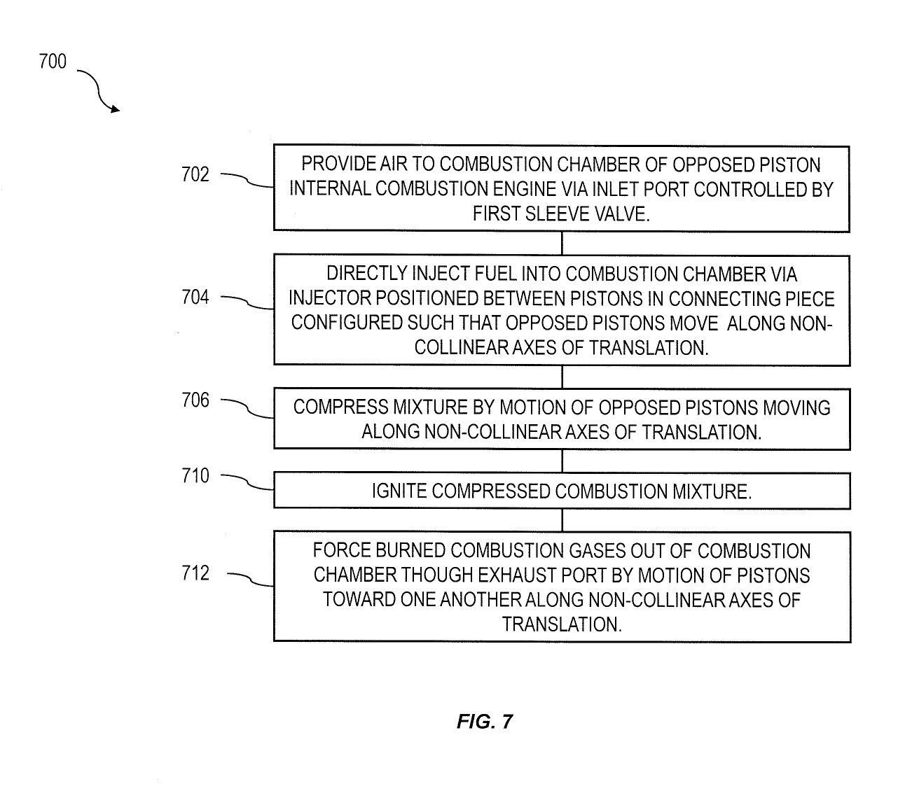

FIG. 6 shows a process flow chart 600 illustrating method features consistent with one or more implementations of the current subject matter. At 602, a combustion mixture, for example including air or another oxidizer and fuel, is provided within a combustion volume or chamber 114 of an opposed piston internal combustion engine. In various examples, air or air and fuel can be provided via one or more inlet ports 116. Fuel can alternatively or additionally be supplied via another port or directly injected, either as a gas or a liquid, into the combustion volume or chamber 114, for example in manner described below in reference to FIG. 7. Flow through the one or more inlet ports 116 can be controlled by motion of a first sleeve valve 122. At 604, the combustion mixture is compressed by motion of two opposed pistons 104, 110 that each move in respective cylinder bores 502, 504 along separate and non-collinear axes of translation 202, 204. The compressed combustion mixture is ignited at 606, for example by at least one ignition element 134 (e.g. at least one spark plug) positioned in a connecting piece 132 at which the two parts of the cylinder are joined. Alternatively, if the engine is a diesel or other engine in which fuel is directly injected into the combustion volume or chamber 114, fuel can be provided by a diesel injector positioned in the connecting piece as discussed below in reference to FIG. 7. After expansion of the ignited mixture, an exhaust port 120 is opened at 610 by motion of a second sleeve valve 124 so that the burned mixture can be forced out of the combustion volume or chamber 114 as the pistons 104, 110 are again moved toward one another.

FIG. 7 shows a process flow chart 700 illustrating method features consistent with one or more implementations of the current subject matter. At 702, air or some other oxidizer is provided to a combustion volume or chamber 114 of an opposed piston internal combustion engine via one or more inlet ports 116. Flow through the one or more inlet ports 116 can be controlled by motion of a first sleeve valve 122. Fuel is supplied directly to the combustion volume or chamber 114 at 704 via an injector, which can optionally be a diesel injector or a compressed fuel injector consistent with those discussed in co-owned and co-pending U.S. provisional application Ser. No. 71/391,487 (entitled “Direct Injection Techniques and Tank Architectures for Internal Combustion Engines with Pressurized Fuels”), the disclosure of which is incorporated by reference herein. The injector used to deliver the fuel at 704 can be positioned in a connecting piece 132 at which the two parts of an engine block defining respective cylinder bores 502, 504 are joined, for example at a position similar to that shown in FIG. 2, FIG. 3, FIG. 4, or FIG. 5 for the ignition element 134. Alternatively, in an engine running on a compressed fuel (e.g. compressed natural gas, liquefied petroleum gas, hydrogen, etc.), which can require a spark plug or other ignition element or ignition source to commence combustion of the air-fuel mixture in the combustion volume or chamber 114, the ignition element 134 can be positioned as shown in FIG. 2, FIG. 3, FIG. 4, or FIG. 5, and an additional direct injection port can be positioned elsewhere to deliver the compressed fuel to the combustion volume or chamber 114. At 706, a combustion mixture is compressed by motion of two opposed pistons 104, 110 that each move in in part of the respective cylinder bores 502, 504 along separate and non-collinear axes of translation 202, 204. The compressed combustion mixture is ignited at 710. After expansion of the ignited mixture, an exhaust port 120 is opened at 712 by motion of a second sleeve valve 124 so that the burned mixture can be forced out of the combustion volume or chamber 114 as the pistons 104, 110 are again moved toward one another.

Implementations of the current subject matter described herein can provide one or more advantages. For example, additional room can be provided in an opposed piston engine to enable use of one or more ignition elements 134, such as conventional spark plugs. The piston crowns 102, 106 can be designed to enhance formation of a “squish” region that causes the air-fuel mixture in the combustion volume or chamber 114 to be pushed closer to the ignition element 134 while generating turbulence to enhance combustion of the air-fuel mixture. Additionally, if the “V” shape formed by non-collinear axes of translation 202, 204 is arranged such that the vertex of the “V” shape is directed upward (e.g. to form an upside down “V”) with reference to a road or other surface upon which a vehicle is supported or operated, when the engine is stopped and or parked, each cylinder bore 502, 504 is arranged with a downward slope such that oil left in the cylinder bore 502, 504 as the engine is stopped will drain out due to gravity. Oil left on the walls 112 of the cylinder bores 502, 504 can drain back to the crankcase, which can potentially eliminate or at least reduce potential problems with smoking or oil burnoff when the engine is started.

Additionally, while one or more of the features discussed herein can provide advantages in ignition element or spark plug placement for a spark-ignited engine, non-spark ignited engines can also realize one or more advantages from a non-collinear configuration of the translation axes 202, 204 of the pistons 104, 110 in an opposed piston engine. A diesel fuel injector can be substituted for the ignition element to provide fuel directly into the combustion volume or chamber 114. While substitution of a diesel injector for the ignition element 134 may not create concerns about spacing in a smaller displacement engine, the additional turbulence generated by the squish regions in an angled engine geometry can be advantageous. Furthermore, a diesel injector is typically a relatively expensive engine component. Use of one or more of the features described herein can reduce the need for multiple injectors, thereby resulting in significant cost savings.

Furthermore, engine configurations consistent with implementations of the current subject matter can provide excellent efficiency characteristics, for example when used in conjunction with systems, methods, articles of manufacture, and features thereof consistent with the descriptions in U.S. Pat. No. 7,559,298 and U.S. Pat. No. 7,921,817. Examples of sleeve valves 122, 124 can include, but are not limited to, those described in U.S. Patent Application Publication No. US2010/0212622. Because of the facing relationship of the first and second pistons 104, 110, there is no cylinder head for either of the first and second pistons 104, 110 through which heat can escape. The facing relationship between the opposed pistons 104, 110 can thus assist in containment of heat energy, with a corresponding increase in efficiency. Additionally, the two opposed pistons 104, 110 can have relatively small diameters compared to the volume of the combustion volume or chamber 114, thereby creating a relatively low surface area to volume ratio that can further assist in reducing heat losses. A reduction in the surface area of a piston crown 102, 106 normally (e.g. in a conventional engine that does not feature an oppose piston geometry) corresponds with an increase in the stroke of the pistons 104, 110 required to obtain the same displacement. However, because an opposed piston engine such as those described herein includes the two crankshafts 136, 138 each connected via a respective offset throw bearing 140, 142 and connecting rod 144, 146 to one of the opposed pistons 104, 110, the stroke of each of the opposed pistons 104, 110 can be approximately half of what would be required in a single piston configuration with the same displacement. Because of the relatively short stroke length of the opposed pistons 104, 110, an opposed piston engine having features described herein and illustrated in the accompanying figures can run at higher revolutions per minute and produce more power than in an arrangement where only a single piston is provided. Such engines can generally have a high compression ratio because the compression is achieved between the pistons 104, 110, by the motion of the pistons in the respective cylinder bores approaching each other. As a result, such engines are capable of generating high power per unit of cylinder volume.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

1. An of an opposed piston internal combustion engine comprising:
a first piston reciprocating along a first axis of translation within a first cylinder bore in an engine block, the first piston reciprocating between a first top dead center position and a first bottom dead center position, the first piston comprising a first piston crown;
a first crankshaft configured to be rotated under influence of the reciprocating of the first piston, the first crankshaft disposed closer to the first bottom dead center position than to the first top dead center position;
a second piston reciprocating along a second axis of translation within a second cylinder bore in the engine block, the second piston reciprocating between a second top dead center position and a second bottom dead center position, the second axis of translation being inclined at an included angle relative to the first axis of translation, the included angle having a vertex that is closer to the first and the second top dead center positions than to the first and the second bottom dead center positions, the second piston comprising a second piston crown, the second piston crown and the first piston crown at least partially defining a combustion chamber within the opposed piston internal combustion engine; and
a second crankshaft configured to be rotated under influence of the reciprocating of the second piston, the second crankshaft disposed closer to the second bottom dead center position than to the second top dead center position.

2. An opposed piston internal combustion engine as in claim 1, wherein the engine block comprises first and second engine block parts that respectively at least partially define the first and second cylinder bores, and a connecting piece disposed proximate to the vertex of the included angle, the first and second engine block parts being joined to the connecting piece, the connecting piece also at least partially defining the combustion chamber.

3. An opposed piston internal combustion engine as in claim 2, further comprising an ignition element disposed in the connecting piece to provide an ignition source to a combustion mixture in the combustion chamber that is compressed by the reciprocating of the first piston and the second piston toward the first and second top dead center positions, respectively.

4. An opposed piston internal combustion engine as in claim 2, further comprising an injector disposed in the connecting piece to provide at least one of fuel and a pre-mixed combustion mixture in the combustion chamber.

5. An opposed piston internal combustion engine as in claim 1, wherein the vertex of the included angle is disposed above a plane containing the first and second crankshafts.

6. An opposed piston internal combustion engine as in claim 1, further comprising: a first sleeve valve associated with the first piston to control opening and closing of an inlet port for allowing delivery of at least one of fuel and air to the combustion chamber, the first sleeve valve at least partially encircling the first piston in the first bore and configured to move at least in a direction parallel to the first axis of translation such that in a first closed position the first sleeve valve is configured to be urged into contact with a first valve seat.

7. An opposed piston internal combustion engine as in claim 1, further comprising: a second sleeve valve associated with the second piston to control opening and closing of an exhaust port for allowing removal of combustion gases from the combustion chamber, the second sleeve valve at least partially encircling the second piston in the second bore and moving at least in a direction parallel to the second axis of translation such that in a second closed position the second sleeve valve is urged into contact with a second valve seat.

8. An opposed piston internal combustion engine as in claim 1, wherein at least one of the first piston crown and the second piston crown comprises a shaped area, the shaped area comprising a concavity directed toward the combustion chamber.

9. An opposed piston internal combustion engine as in claim 8, wherein the concavity of the shaped area is also at least partially directed toward the vertex of the included angle.

10. An opposed piston internal combustion engine as in claim 1, wherein the included angle is greater than 0° and smaller than 180°.

11. An opposed piston internal combustion engine as in claim 1, wherein the included angle is in a range of approximately 130° to 170°.

12. An opposed piston internal combustion engine as in claim 1, wherein the included angle is approximately 160°.

13. A method comprising:
reciprocating a first piston between a first top dead center position and a first bottom dead center position along a first axis of translation within a first cylinder bore in an engine block of an opposed piston internal combustion engine, the first piston comprising a first piston crown;
rotating a first crankshaft under influence of the reciprocating of the first piston, the first crankshaft disposed closer to the first bottom dead center position than to the first top dead center position;
reciprocating a second piston between a second top dead center position and a second bottom dead center position along a second axis of translation within a second cylinder bore in the engine block, the second axis of translation being inclined at an included angle relative to the first axis of translation, the included angle having a vertex that is closer to the first and the second top dead center positions than to the first and the second bottom dead center positions, the second piston comprising a second piston crown, the second piston crown and the first piston crown at least partially defining a combustion chamber within the opposed piston internal combustion engine; and
rotating a second crankshaft under influence of the reciprocating of the second piston, the second crankshaft disposed closer to the second bottom dead center position than to the second top dead center position.

14. A method as in claim 13, wherein the engine block comprises first and second engine block parts that respectively at least partially define the first and second cylinder bores, and a connecting piece disposed proximate to the vertex of the included angle, the first and second engine block parts being joined to the connecting piece, the connecting piece also at least partially defining the combustion chamber.

15. A method as in claim 14, wherein at least one ignition element is disposed in the connecting piece to provide an ignition source to a combustion mixture formed in the combustion chamber and compressed by the reciprocating of the first piston and the second piston toward the first and second top dead center positions, respectively.

16. A method as in claim 14, wherein at least one injector is disposed in the connecting piece to provide at least one of fuel and a pre-mixed combustion mixture to the combustion chamber.

17. A method as in claim 13, wherein the vertex of the included angle is disposed above a plane comprising the first and second crankshafts.

18. A method as in claim 13, wherein a first sleeve valve is associated with the first piston to control opening and closing of an inlet port for allowing delivery of at least one of fuel and air to the combustion chamber, the first sleeve valve at least partially encircling the first piston in the first bore and moving at least in a direction parallel to the first axis of translation such that in a first closed position the first sleeve valve is urged into contact with a first valve seat.

19. A method as in claim 13, wherein a second sleeve valve is associated with the second piston to control opening and closing of an exhaust port for allowing removal of combustion gases from the combustion chamber, the second sleeve valve at least partially encircling the second piston in the second bore and moving at least in a direction parallel to the second axis of translation such that in a second closed position the second sleeve valve is urged into contact with a second valve seat.

20. A method as in claim 13, wherein at least one of the first piston crown and the second piston crown comprises a shaped area, the shaped area comprising a concavity directed toward the combustion chamber.

21. (canceled)

22. (canceled)

23. (canceled)

24. (canceled)
